(19) United States
(12) Patent Application Publication
(10) Pub. No.: US 2026/0088549 A1
(43) Pub. Date: Mar. 26, 2026

(54) ELECTRICAL CONNECTOR

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventor: FANG-JWU LIAO, New Taipei (TW)

(21) Appl. No.: 19/337,873

(22) Filed: Sep. 23, 2025

(30) Foreign Application Priority Data
Sep. 24, 2024 (CN) 202411332898.2

(51) Int. Cl. H01R 13/24; H01R 13/50; H01R 13/6474

(52) U.S. Cl. CPC H01R 13/2435; H01R 13/50; H01R 13/6474

(57) ABSTRACT

An electrical connector includes an insulating housing having terminal slots, and a terminals arranged respectively in the terminal slots. Each terminal has a main portion fixed in a corresponding terminal slot, an upper resilient portion, an upper contacting portion, an upper abutting portion, a lower resilient portion, a lower contacting portion, and a lower abutting portion. The upper resilient portion, the upper contacting portion, and the upper abutting portion extend sequentially from the main portion. The lower resilient portion, the lower contacting portion, and the lower abutting portion extend sequentially from the main portion. An amount of the upper contacting portion and an amount of the lower contacting portion are one or two. An amount of the upper abutting portion is different from the amount of the upper contacting portion, and an amount of the lower abutting portion is different from the amount of the lower contacting portion.

### BACKGROUND OF THE INVENTION

### Field of the Invention

The present invention relates to an electrical connector.

### Description of Related Arts

Current electrical connectors have increasingly higher transmission speeds. Bandwidths of some connectors have reached 128 Gbps. A higher requirement is needed regarding impedance of high frequency connectors having high speed transmissions.

U.S. Patent Application Publication No. 2023/0074510 discloses a terminal having an upper contacting portion and an upper abutting end that are a resilient sheet of a same width, and a lower contacting portion and a lower abutting end that are a resilient sheet of a same width. The impedance of the terminal might not meet the requirement of high frequency in certain circumstances.

Therefore, an improved electrical connector is needed.

### SUMMARY OF THE INVENTION

The present disclosure provides an electrical connector having a better high frequency performance.

The present disclosure can provide an electrical connector including an insulating housing and a plurality of terminals. The insulating housing has an upper face, a lower face, and a plurality of terminal slots. The plurality of terminals are arranged respectively in the terminal slots. Each terminal has a main portion fixed in a corresponding terminal slot, an upper resilient portion, an upper contacting portion, an upper abutting portion, a lower resilient portion, a lower contacting portion, and a lower abutting portion. The upper resilient portion, the upper contacting portion, and the upper abutting portion extend upward sequentially from the main portion. The lower resilient portion, the lower contacting portion, and the lower abutting portion extend downward sequentially from the main portion. When the upper contacting portion and the lower contacting portion move toward the insulating housing, the upper abutting portion and the lower abutting portion abut each other. An amount of the upper contacting portion is one, an amount of the lower contacting portion is one, an amount of the upper abutting portion is two, and an amount of the lower abutting portion is two.

The present disclosure can provide an electrical connector including an insulating housing and a plurality of terminals. The insulating housing has an upper face, a lower face, and a plurality of terminal slots. The plurality of terminals are arranged respectively in the terminal slots. Each terminal has a main portion fixed in a corresponding terminal slot, an upper resilient portion, an upper contacting portion, an upper abutting portion, a lower resilient portion, a lower contacting portion, and a lower abutting portion. The upper resilient portion, the upper contacting portion, and the upper abutting portion extend upward sequentially from the main portion. The lower resilient portion, the lower contacting portion, and the lower abutting portion extend downward sequentially from the main portion. When the upper contacting portion and the lower contacting portion move toward the insulating housing, the upper abutting portion and the lower abutting portion abut each other. An amount of the upper contacting portion is two, an amount of the lower contacting portion is two, an amount of the upper abutting portion is one, and an amount of the lower abutting portion is one.

The present disclosure can provide a terminal including a main portion, a first resilient portion extending from the main portion, at least one first contacting portion extending from the first resilient portion, at least one first abutting portion extending from the first contacting portion, a second resilient portion extending from the main portion, at least one second contacting portion extending from the second resilient portion; and at least one second abutting portion extending from the second contacting portion. The at least one first contacting portion and the at least one second contacting portion bend toward each other. The at least one first abutting portion and the at least one second abutting portion extend toward each other and toward the main portion. The at least one upper contacting portion is offset from the at least one upper abutting portion. The at least one lower contacting portion is offset from the at least one lower abutting portion.

The present disclosure improves the impedance of the terminals by specific arrangements of the contacting portions and the abutting portions of the terminals, such that high frequency signals can be better transmitted and better high frequency performance can be achieved.

### BRIEF DESCRIPTION OF DRAWINGS

FIG. 1 shows a perspective view of an electrical connector according to a first embodiment of the present disclosure;

FIG. 2 shows a perspective view of the electrical connector of FIG. 1 from another perspective;

FIG. 3 shows a bottom view of the electrical connector of FIG. 1;

FIG. 4 shows a bottom view of the electrical connector of FIG. 1, wherein an upper contacting portion and a lower contacting portion are pressed toward an insulating housing;

FIG. 5 shows a rear view of the electrical connector of FIG. 1;

FIG. 6 shows a perspective view of a terminal of FIG. 1;

FIG. 7 shows a perspective view of the terminal of FIG. 6 from another perspective;

FIG. 8 shows a rear view of the terminal of FIG. 6;

FIG. 9 shows a perspective view of the terminal of FIG. 6 after being compressed, wherein an upper abutting portion and a lower abutting portion of the terminal contact each other;

FIG. 10 shows a cross-sectional view of the electrical connector of FIG. 4 along cut line A-A;

FIG. 11 shows a perspective view of a terminal according to a second embodiment of the present disclosure;

FIG. 12 shows a perspective view of the terminal of FIG. 11 from another perspective; and

FIG. 13 shows a perspective view of the terminal of FIG. 11 after being compressed, wherein an upper butting portion and a lower abutting portion of the terminal contact each other.

### DETAILED DESCRIPTION OF THE DRAWINGS

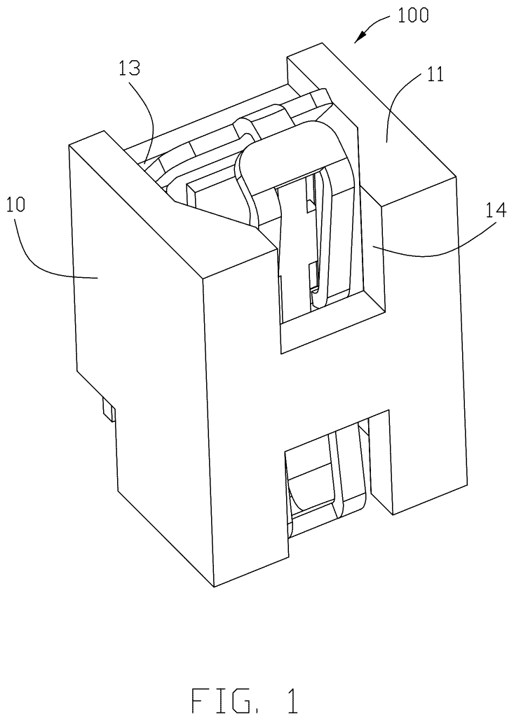

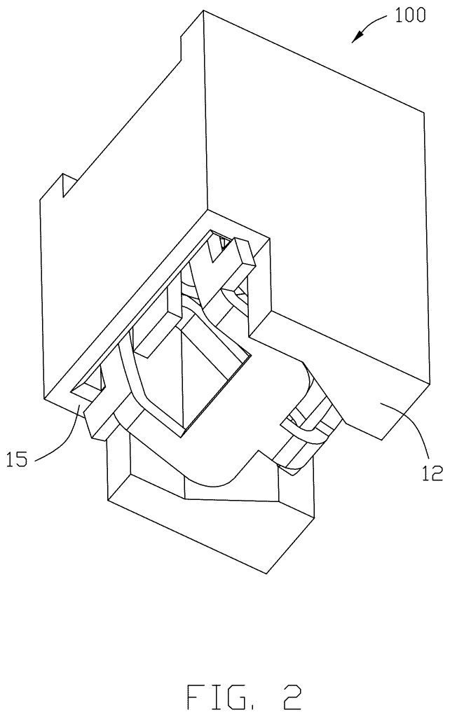

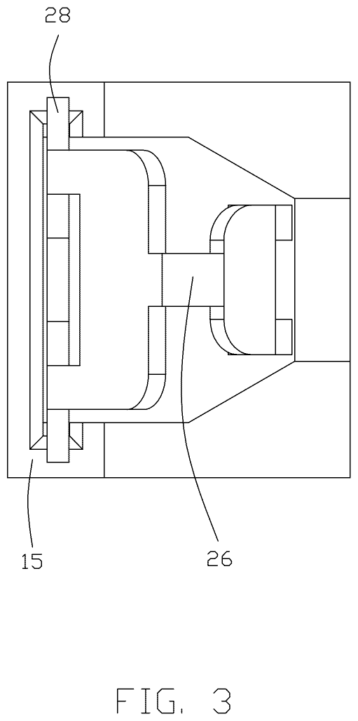

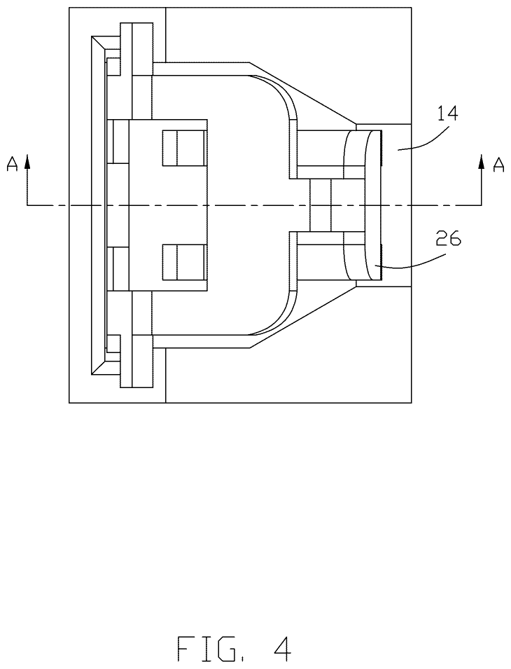

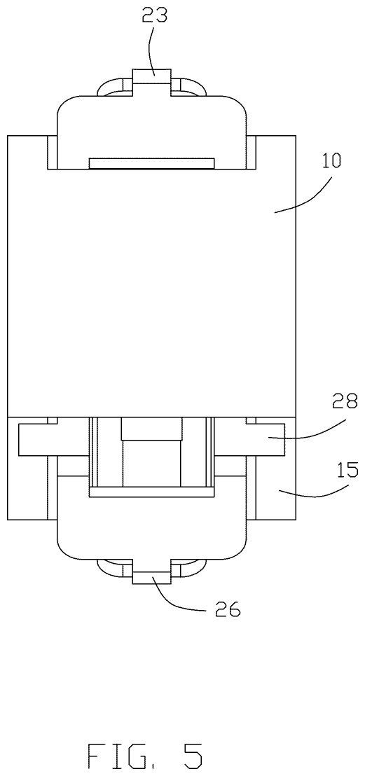

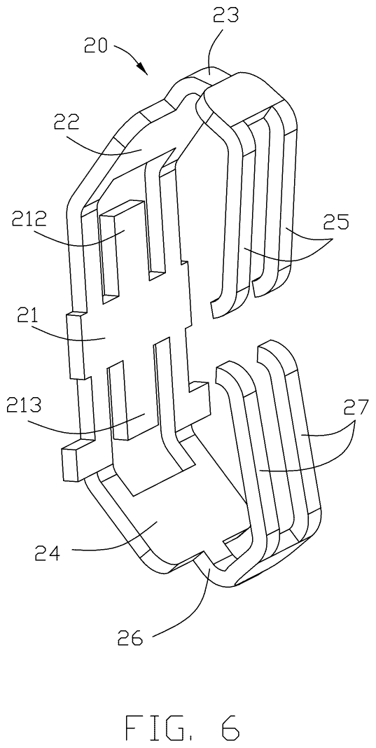

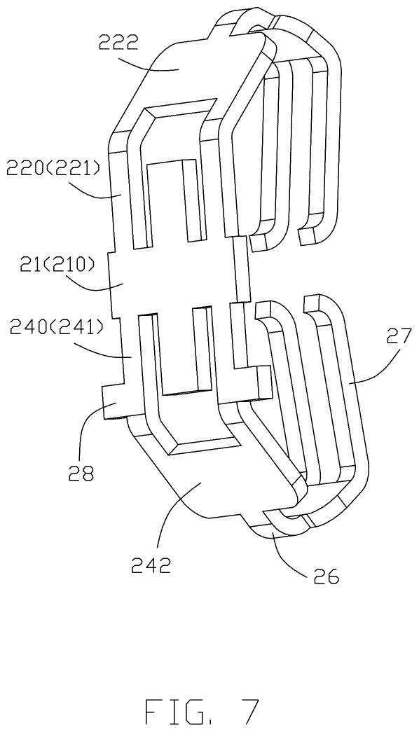

FIGS. 1-5 show an electrical connector 100 for electrically connecting a chip (not shown in the figures) to a circuit board or other elements (not shown in the figures), according to a first embodiment of the present disclosure. The electrical connector 100 includes an insulating housing 10 and a plurality of terminals 20. The insulating housing 10 has an upper face 11, a lower face 12, and terminal slots 13 passing through the upper face 11 and the lower face 12. The terminals 20 are respectively arranged in the terminal slots 13. The present embodiment shows only one of the terminals 20 of the electrical connector 100 and the terminal slot 13 for accommodating said terminal 20. In practice, a product can have a plurality of terminals 20 arranged in array. Referring to FIGS. 6-7, the terminal 20 includes a main portion 21 fixed in the terminal slot 13, an upper resilient portion 22 and an upper contacting portion 23 extending sequentially upward from the main portion 21, an upper abutting portion 25, a lower resilient portion 24 and a lower contacting portion 26 extending sequentially downward from the main portion 21, and a lower abutting portion 27. When the upper contacting portion 23 and the lower contacting portion 26 are pressed and move toward the insulating housing 10, the upper abutting portion 25 and the lower abutting portion 27 abut each other. In the present embodiment, the amount of the upper contacting portion 23 is one, the amount of the lower contacting portion 26 is one, the amount of the upper abutting portion 25 is two, and the amount of the lower abutting portion 27 is two.

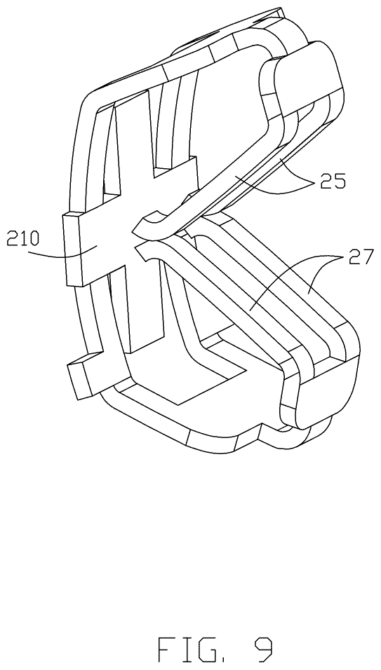

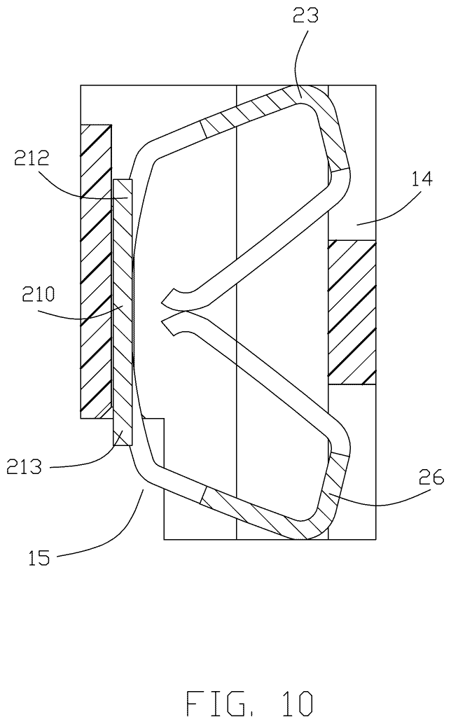

Referring to FIGS. 6-8, the upper resilient portion 22 extends vertically upward from the main portion 21 and then extends at an inclined angle out of the upper face 11 of the insulating housing 10, the upper contacting portion 23 is a V-shaped structure bending downward, and the upper abutting portion 25 extends from the upper contacting portion 23 downward and toward the main portion 21. The lower resilient portion 24 extends vertically downward from the main portion 21 and then extends at an inclined angle out of the lower face 12 of the insulating housing 10, the lower contacting portion 26 is a V-shaped structure bending upward, and the lower abutting portion 27 extends from the lower contacting portion 26 upward and toward the main portion 21. Preferably, in the present embodiment, the main portion 21 extends vertically, the upper resilient portion 22 of the terminal 20 includes a vertical portion 221 positioned in a same plane as the main portion 21, and an inclined portion 222 extending upward from the vertical portion 221 at an inclined angle. Similar to the upper resilient portion 22, the lower resilient portion 24 includes a vertical portion 241 positioned in a same plane as the main portion 21, and an inclined portion 242 extending downward from the vertical portion 241 at an inclined angle. A width of the upper contacting portion 23 changes abruptly from a width of the upper resilient portion 22, and is not tapered gradually. Preferably, the terminal 20 is arranged symmetrically in a up-down direction, and the structures of the lower contacting portion 26 and the upper contacting portion 23 are similar. Referring to FIGS. 9-10, when the upper contacting portion 23 and the lower contacting portion 26 each move toward the insulating housing 10, the two upper abutting portions 25 respectively correspond to and abut the two lower abutting portions 27.

Referring to FIGS. 6-7, at least portions of the upper resilient portion 22 and the lower resilient 24 are carved out and form a horizontal bar portion 210 and two vertical bar portions 240. The horizontal bar portion 210 and the two vertical bar portions 240 form a frame. Horizontal edges of the horizontal bar portion 210 form hook regions. In the present embodiment, the upper resilient portion 22 and the lower resilient portion 24 are carved out at portions proximal to the main portion 21, such that the terminal 20 is formed with the horizontal bar portion 210 and two vertical bar portions 220, 240 arranged respectively at two sides of the horizontal bar portion 210. The two vertical bar portions 220, 240 include two upper vertical bar portions 220 positioned above the horizontal bar portion 210 and two lower vertical bar portions 240 positioned below the horizontal bar portion 210. The horizontal bar portion 210 and the two upper vertical bar portions 220 form an upper frame. The horizontal bar portion 210 and the two lower vertical bar portions 240 form a lower frame.

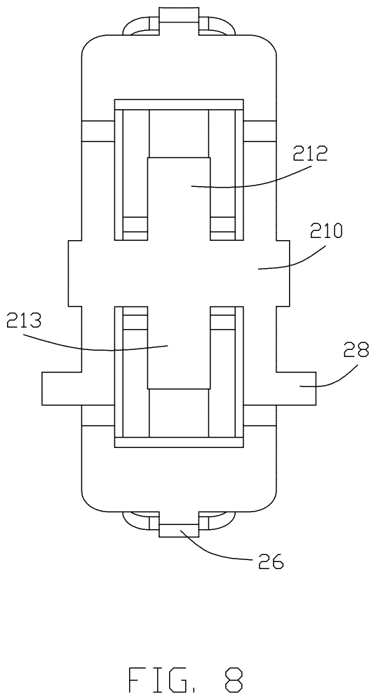

In the present embodiment, the horizontal bar portion 210 is the main portion 21. In other embodiments, they can be different structures, for example the upper frame is formed by carving out portions of the upper resilient portion 22 and the main portion 21, the lower frame is formed by carving out portions of the lower resilient portion 24 and the main portion 21, such that the horizontal bar portion 210 is formed after caving out upper and lower portions of the main portion 21. Referring to FIGS. 6-7, in the present embodiment, in order to reduce impedance, an upper bar portion 212 extends upward from the upper edge of the horizontal bar portion 210, and a lower bar portion 213 extends downward from the lower edge of the horizontal bar portion 210. The upper bar portion 212 and the lower bar portion 213 are respectively positioned in the upper frame and the lower frame. Referring to FIG. 8, viewing from a direction normal to the main portion 21, the upper bar portion 212 is positioned between the two upper abutting portions 25, and the lower bar portion 213 is positioned between the two lower abutting portions 27. Proximal to two sides of the lower resilient portions 24, the terminal 20 is formed with material strip connecting portions 28. The upper bar portion 212 and the lower bar portion 213 are symmetrically arranged in the upper resilient portion 22 and the lower resilient portion 24, reducing the Stub effect, namely reducing the antenna effect of the terminal. Preferably, the material strip connecting portions 28 are arranged proximal to the connecting part between the vertical portion 241 and the inclined portion 242, and in the up-down direction, the lower bar portion 213 extends downward to and at least partially overlaps with the material strip connecting portions 28.

Referring to FIGS. 1-4 and 10, proximal to the terminal slot 13, the insulating housing 10 has a receiving space 14. When the upper contacting portion 23 and the lower contacting portion 26 move toward the insulating housing 10, namely after the terminal 20 is compressed, the upper contacting portion 23 and the lower contacting portion 26 of the terminal 20 can enter the receiving space 14. Proximal to the insulating slot 13, the insulating housing 10 has a second receiving space 15. The two material strip connecting portions 28 are positioned in the second receiving space 15.

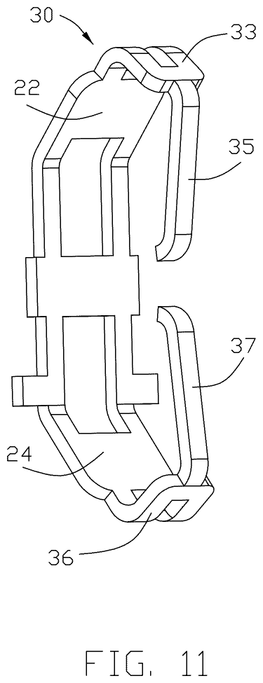

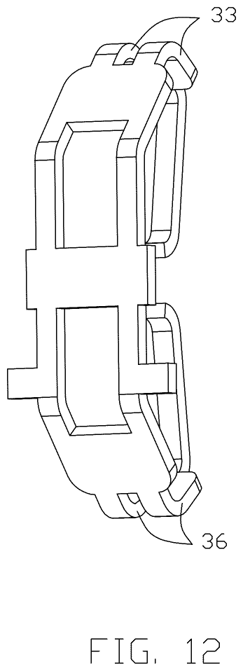

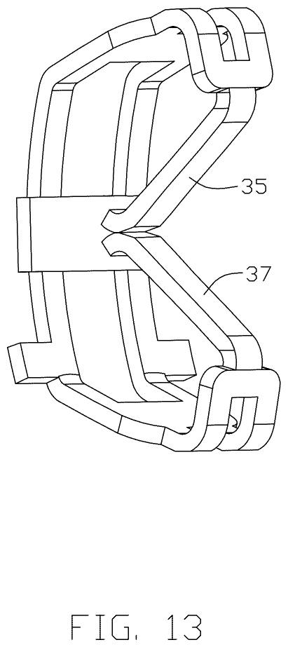

FIGS. 11-13 show a terminal 30 according to a second embodiment of the present disclosure. In the present embodiment, the terminal 30 has a structure similar to that of the terminal 20 of the first embodiment. Similar structures are labeled similarly, and not further described. The following mainly describes the differences. In the present embodiment, an amount of an upper contacting portion 33 of the terminal 30 is two, an amount of a lower contacting portion 36 is two, an amount of an upper abutting portion 35 is one, and an amount of a lower abutting portion 37 is one. A width of the upper contacting portion 33 changes abruptly from a width of the upper abutting portion 35, and is not tapered gradually. A width of the lower contacting portion 36 changes abruptly from a width of the lower abutting portion 37, and is not tapered gradually. Preferably, the width of the upper contacting portion 33 abruptly narrows relative to the upper resilient portion 22, and abruptly widens relative to the upper abutting portion 35. Namely the width of the upper abutting portion 35 abruptly narrows relative to the upper contacting portion 33. The upper contacting portion 33 is V-shaped, formed by two V-shaped arms spaced apart from each other. The terminal 30 is configured as a mirror image in an up-down direction, thus similar to the upper contacting portion 33 and the upper abutting portion 35, the width of the lower contacting portion 36 abruptly narrows relative to the lower resilient portion 24, and the width of the lower abutting portion 37 abruptly narrows relative to the lower contacting portion 36. The lower contacting portion 36 is also V-shaped, and formed by two V-shaped arms spaced apart from each other. Additionally, different from the first embodiment, in the present embodiment, the terminal 30 does not have the upper bar portion 212 and the lower bar portion 213 respectively extending from the upper and lower edges of the horizontal bar portion 210.

In summary, in the present disclosure, an amount of the upper and lower contact portions is one, and an amount of the upper and lower abutting portions is two. Alternately, an amount of the upper and lower contact portions is two, and an amount of the upper and lower abutting portions is one. Thereby, stress on the terminal when compressed is improved, and multiple electrical circuit is achieved, improving the high frequency performance of the electrical connector.

The above are only preferred embodiments of the present disclosure and should not be used to limit the scope of the present disclosure. That is, any simple equivalent changes and modifications made according to the scope of the present disclosure and the content of the present disclosure should still fall within the scope of the present disclosure.

1. An electrical connector comprising:
an insulating housing having an upper face, a lower face, and a plurality of terminal slots; and
a plurality of terminals arranged respectively in the terminal slots, each terminal having a main portion fixed in a corresponding terminal slot, an upper resilient portion, an upper contacting portion, an upper abutting portion, a lower resilient portion, a lower contacting portion, and a lower abutting portion; wherein
the upper resilient portion, the upper contacting portion, and the upper abutting portion extend upward sequentially from the main portion, the lower resilient portion, the lower contacting portion, and the lower abutting portion extend downward sequentially from the main portion, when the upper contacting portion and the lower contacting portion move toward the insulating housing, the upper abutting portion and the lower abutting portion abut each other, an amount of the upper contacting portion is one, an amount of the lower contacting portion is one, an amount of the upper abutting portion is two, and an amount of the lower abutting portion is two.

2. The electrical connector according to claim 1, wherein a portion of the upper resilient portion and a portion of the lower resilient portion are carved out to form a horizontal bar portion and two vertical bar portions, and the horizontal bar portion and the two vertical bar portions form a frame.

3. The electrical connector according to claim 2, wherein the terminal has material strip connecting portions proximal respectively to two sides of the lower resilient portion.

4. The electrical connector according to claim 2, wherein horizontal edges of the horizontal bar portion form hook regions.

5. The electrical connector according to claim 2, wherein an upper bar portion extend upward from an upper edge of the horizontal bar portion, a lower bar portion extend downward from a lower edge of the horizontal bar portion, and the upper bar portion and the lower bar portion are positioned in the frame.

6. The electrical connector according to claim 5, wherein viewing from a direction normal to the main portion, the upper bar portion is positioned between the two upper abutting portions, and the lower bar portion is positioned between the two lower abutting portions.

7. The electrical connector according to claim 1, wherein a width of the upper contacting portion abruptly changes relative to a width of the upper resilient portion, and is not tapered gradually; and a width of the lower contacting portion abruptly changes relative to a width of the lower resilient portion, and is not tapered gradually.

8. The electrical connector according to claim 1, wherein a width of the upper contacting portion abruptly change relative to a width of the upper abutting portions, and is not tapered gradually; a width of the lower contacting portion abruptly changes relative to a width of the lower abutting portions, and is not tapered gradually.

9. The electrical connector according to claim 1, wherein the upper resilient portion extends vertically upward from the main portion and then extends at an inclined angle out of the insulating housing, the upper contacting portion is a V-shaped structure bending downward, the upper abutting portions extend from the upper contacting portion downward and toward the main portion, the lower resilient portion extends vertically downward from the main portion and then extends at an inclined angle out of the insulating housing, the lower contacting portion is a V-shaped structure bending upward, and the lower abutting portions extend from the lower contacting portion upward and toward the main portion.

10. The electrical connector according to claim 1, wherein the insulating housing has a first receiving space proximal to each one of the terminal slots, when the upper contacting portion and the lower contacting portion move toward the insulating housing, the upper contacting portion and the lower contacting portion can enter the first receiving space.

11. The electrical connector according to claim 10, wherein the insulating housing has a second receiving space proximal to each one of the terminal slots, the terminal has material strip connecting portions respectively proximal to two sides of the lower resilient portion.

12. An electrical connector comprising:
an insulating housing having an upper face, a lower face, and a plurality of terminal slots; and
a plurality of terminals arranged respectively in the terminal slots, and each having a main portion fixed in the respective terminal slot, an upper resilient portion, an upper contacting portion, an upper abutting portion, a lower resilient portion, a lower contacting portion, and a lower abutting portion; wherein
the upper resilient portion, the upper contacting portion, and the upper abutting portion extend upward sequentially from the main portion, the lower resilient portion, the lower contacting portion, and the lower abutting portion extend downward sequentially from the main portion, when the upper contacting portion and the lower contacting portion move toward the insulating housing, the upper abutting portion and the lower abutting portion abut each other, an amount of the upper contacting portion is two, an amount of the lower contacting portion is two, an amount of the upper abutting portion is one, and an amount of the lower abutting portion is one.

13. The electrical connector according to claim 12, wherein a width of the upper contacting portions abruptly changes relative to a width of the upper resilient portion, and is not tapered gradually; and a width of the lower contacting portions abruptly changes relative to a width of the lower resilient portion, and is not tapered gradually.

14. The electrical connector according to claim 12, wherein a width of the upper contacting portions abruptly change relative to a width of the upper abutting portion, and is not tapered gradually; a width of the lower contacting portions abruptly changes relative to a width of the lower abutting portion, and is not tapered gradually.

15. The electrical connector according to claim 12, wherein the upper resilient portion extends vertically upward from the main portion and then extends at an inclined angle out of the insulating housing, the upper contacting portions are V-shaped structures spaced apart and bending downward, the upper abutting portion extends from the upper contacting portion downward and toward the main portion, the lower resilient portion extends vertically downward from the main portion and then extends at an inclined angle out of the insulating housing, the lower contacting portions are V-shaped structures spaced apart and bending upward, and the lower abutting portion extends from the lower contacting portion upward and toward the main portion.

16. The electrical connector according to claim 12, wherein the insulating housing has a first receiving space proximal to each one of the terminal slots, when the upper contacting portions and the lower contacting portions move toward the insulating housing, the upper contacting portions and the lower contacting portions can enter the first receiving space.

17. The electrical connector according to claim 16, wherein the insulating housing has a second receiving space proximal to each one of the terminal slots, the terminal has material strip connecting portions respectively proximal to two sides of the lower resilient portion.

18. A terminal comprising:
a main portion;
a first resilient portion extending from the main portion;
at least one first contacting portion extending from the first resilient portion;
at least one first abutting portion extending from the first contacting portion;
a second resilient portion extending from the main portion;
at least one second contacting portion extending from the second resilient portion; and
at least one second abutting portion extending from the second contacting portion; wherein
the at least one first contacting portion and the at least one second contacting portion bend toward each other, the at least one first abutting portion and the at least one second abutting portion extend toward each other and toward the main portion, the at least one upper contacting portion is offset from the at least one upper abutting portion, and the at least one lower contacting portion is offset from the at least one lower abutting portion.
